(19) United States
(12) Patent Application Publication
(10) Pub. No.: US 2005/0006902 A1
(43) Pub. Date: Jan. 13, 2005

(54) EPE (electronic perpetual engine)

(76) Inventor: Matthew R. Patching, Woodland, WA (US)

Correspondence Address: Matthew R. Patching, 1473 N. Goeri #32, Woodland, WA, 98674, US

(21) Appl. No.: 10/414,339

(22) Filed: Jul. 7, 2003

(51) Int. Cl. H02P 9/04

(52) U.S. Cl. 290/1 R

(57) ABSTRACT

The EPE is a machine that produces more electricity than it uses for the process, being entirely self-efficient creating perpetual energy. This is accomplished by two methods by using Mechanical Advantage and multiple Dynamos. The EPE turns Electrical Energy into Mechanical Energy and then back into Electrical Energy. There are six basic parts to the EPE (see drawing 1). A. Motor B. Battery C. Dynamo D. Large Gear E. Small Gear F. Magnets The EPE can be as big as a house or as small as a baseball. The Mechanical Advantage ratio and the number of Dynamos can very greatly depending on electrical load demands. This process can create either AC or DC electricity.

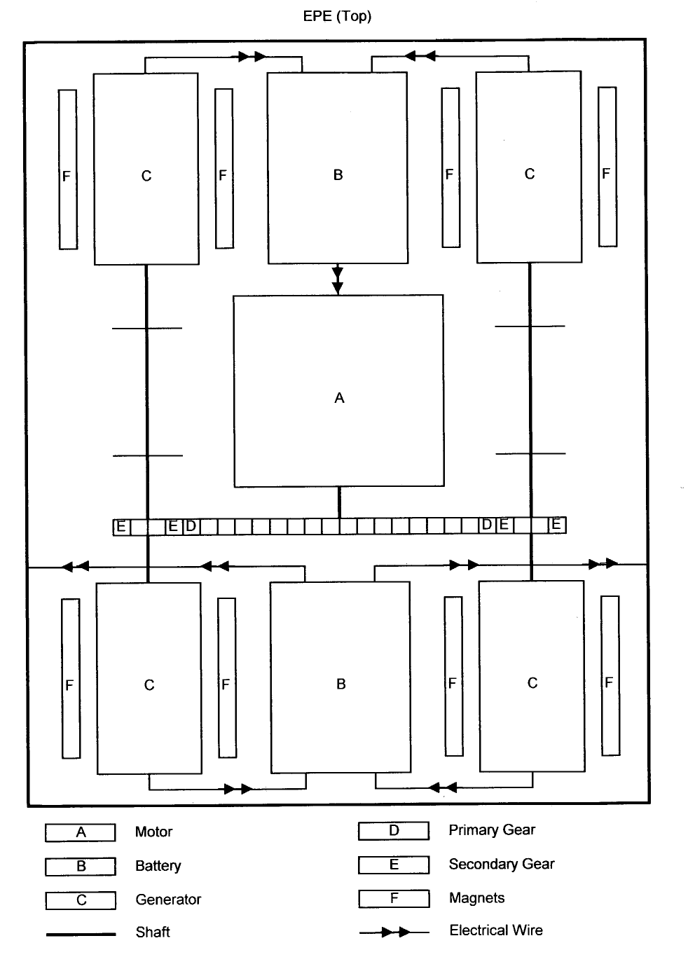

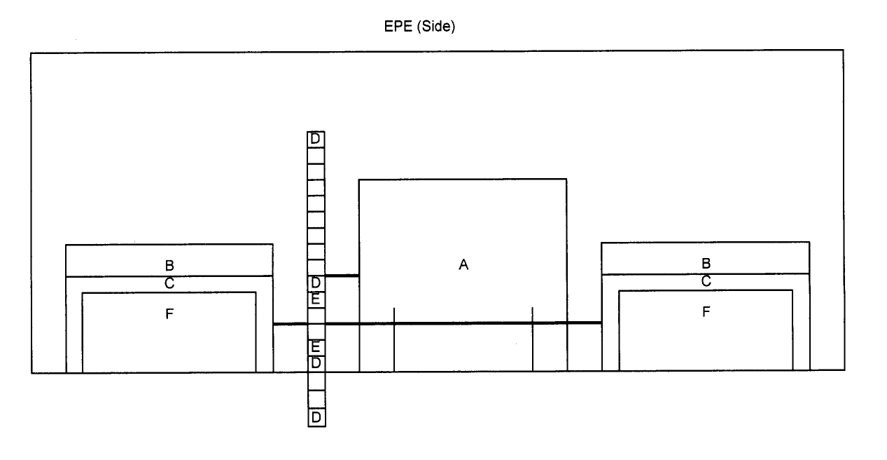

In theory a machine cannot generate enough power to support it's own operation. The EPE has been tricked into generating more electricity by having more than one Dynamo (Generator). Even more power is generated through Mechanical Advantage; the ratio of the output force to the input force applied; Random House Dictionary.

### EXAMPLE

A bicycle, the pedals are connected to the large gear which turn the small gear attached to the rear tire using a chain. The small gear has less of a circumference enabling it to have more revolutions than the large gear. If there is a 1:2 ratio and the large gear has 10 revolutions, the small gear will have 20 revolutions. Making the bicycle move faster than the rider is pedaling.

The EPE starts its cycle at the Battery (label B drawing 1) providing an electrical source for the Motor (label A drawing 1). The Motor turns Electrical Energy into Mechanical Energy thus rotating a shaft. At the end of the shaft is a Large Gear (label D drawing 1). On either side of the Large Gear are two Small Gears (label E drawing 1). Two shafts are on either side running through the center of the Small Gears. At both ends of the shafts are two sets of Dynamos (label C drawing 1). The Dynamo turns Mechanical Energy into Electrical Energy. A Dynamo generates electricity by turning a wire loop within an Electromagnetic field. Wrapped around the loop is a coil made of an electrical Conductor such as Copper and from the Dynamo the electricity travels along a wire to the Battery (label B drawing 1). There are two Batteries. Each Battery is connected to two Dynamos making four total. One Battery powers the Motor and the other Battery is used as a surplus of electricity to the outside, making it available for everyday use.

The EPE can replace all other sources of electricity it can be used in any product that requires a source of electricity. A device such as this may have a major impact on our global energy crisis.

1. The EPE has the ability to produce more electricity than it uses for its own operation creating perpetual energy. This belief goes against every current law of Science in the academic world. It is generally accepted that a machine cannot produce enough energy for its own operation. The EPE contradicts this line of thinking. This new concept of the EPE eliminates the need of almost all other sources of energy.
